(19) United States
(12) Patent Application Publication
(10) Pub. No.: US 2026/0365176 A1
(43) Pub. Date: Nov. 19, 2026

(54) Method and Apparatus for Controlling an Automated Driving Function

(71) Applicant: Bayerische Motoren Werke Aktiengesellschaft, Muenchen (DE)

(72) Inventor: Gunter HANNIG, Fuerstenfeldbruck (DE)

(21) Appl. No.: 19/677,094

(22) Filed: May 14, 2026

(30) Foreign Application Priority Data
May 15, 2025 (DE) 10 2025 118 894.7

(51) Int. Cl. B60W 30/18; B60W 50/14; B60W 60/00

(52) U.S. Cl. CPC B60W 30/18163; B60W 50/14; B60W 60/001; B60W 2420/403; B60W 2520/10; B60W 2540/225

(57) ABSTRACT

A method and an apparatus are provided for controlling an automated driving function of a vehicle. The automated driving function is configured to perform a lane change of the vehicle when predetermined triggering conditions are present. The viewing direction of a user of the vehicle is detected and the detected viewing direction of the user is compared with a traffic-facing target viewing direction. The lane change is suppressed or performed in a slowed-down manner despite the presence of the predetermined triggering conditions if the comparison reveals a deviation of the detected viewing direction from the traffic-facing target viewing direction.

### CROSS REFERENCE TO RELATED APPLICATION

This application claims priority under 35 U.S.C. §119 from German Patent Application No. 10 2025 118 894.7, filed May 15, 2025, the entire disclosure of which is herein expressly incorporated by reference.

### BACKGROUND AND SUMMARY

The invention relates to a method and an apparatus for controlling an automated driving function, which includes triggering a lane change of a vehicle.

In the field of automated driving, a distinction is made between different automation levels from L0 to L5 (L: level) according to the SAE standard. There is no automation at L0, while L5 describes fully autonomous driving without human intervention. At the intermediate levels L1 to L4, the driving task is shifted gradually from the driver to the vehicle.

Up to now, no solutions have yet been known which deal with the problem of motion-related nausea, also known as kinetosis, travel sickness or motion sickness, in the field of highly automated driving. It can be assumed that kinetosis occurs in particular during lane changes which are carried out at higher lateral speeds which occur frequently, but not only, at high speeds.

In ongoing development, lane change strategies which are intended to be used in the future at the higher automation levels SAE L3 to L5 are being derived from systems which are assigned to the lower automation levels SAE L0 to L2. The result of this is that, according to these strategies, the lane change is intended to take place as promptly as possible and be carried out quickly in order to adapt to the normal driving behavior of a human driver. If the vehicle user works in such a highly automated system during driving, for example on a laptop, the fact that the vehicle user does not direct his gaze straight ahead at the traffic in front of him, but rather downward at his laptop, can lead to the lateral acceleration that occurs during a fast lane change causing him to feel sick.

With regard to the prior art, reference is made to document DE 10 2023 106572 A1, in which a method for enabling a functional level of a driving assistance system is described. In this method, environmental data as well as gaze movement data relating to the driver are received. An attention level of the driver is determined on the basis of the gaze movement data. Depending on this attention level, an enable signal is output which enables a corresponding functional level of the driving assistance system for operation.

Document DE 10 2021 126 254 A1 discloses a system which monitors the attention and cognitive load of vehicle occupants by comparing field-of-view information with external vehicle perception. On the basis of this comparison, measures are then taken, for example a warning is output or a safety system is activated.

Document DE 10 2015 201 588 B4 describes a method in which data about the attention of the driver are acquired. To this end, the position and orientation of the eyes of the driver are detected. The attention data are stored and used to generate control parameters in order to enable long-term adaptation of the system.

In the above-mentioned prior art, too, there are no approaches to solutions aimed at preventing the occurrence of kinetosis in the field of autonomous driving.

The object of the invention is to provide a method and an apparatus for controlling an automated driving function, which prevent a lane change brought about by the driving function from causing kinetosis in a vehicle user.

This object is achieved by a method and by an apparatus having the features of the independent claims. Advantageous developments are specified in the dependent claims.

The invention provides a method for controlling an automated driving function of a vehicle, in which the automated driving function is configured to carry out a lane change of the vehicle when predetermined triggering conditions are present. In the method, the viewing direction of a user of the vehicle is detected. The detected viewing direction of the user is compared with a traffic-facing target viewing direction. According to the invention, the lane change is performed in a slowed-down manner or suppressed despite the presence of the predetermined triggering conditions if the comparison reveals a deviation of the detected viewing direction from the traffic-facing target viewing direction.

The invention makes it possible for a vehicle user to use a driving function which, depending on the respective traffic situation, also provides for a lane change without being exposed to the risk of the lane change causing kinetosis in him. Often, the cause of such kinetosis lies in a discrepancy between what the user feels with his vestibular sense of lateral and/or longitudinal acceleration and what he visually senses. The invention therefore provides for the lane change to only be performed in the manner defined within the scope of the automated driving function, in particular on the basis of traffic-related parameters, such as traffic density, speed, oncoming traffic, visibility conditions, etc., if a correspondence between the current viewing direction of the user and a traffic-facing target viewing direction is determined. This target viewing direction indicates a predetermined direction in which the user is looking in order to perceive the traffic situation in front of him in the direction of travel. If, on the other hand, it is determined that such a correspondence is not present, the lane change is suppressed or at least performed so slowly that kinetosis of the vehicle user is avoided.

The vehicle user whose viewing direction is detected and compared with the target viewing direction is generally the driver, that is to say the person located on the driver's seat. However, it is likewise possible to also carry out the control of the lane change according to the invention with respect to one or more other vehicle occupants. For example, the automated lane change can be performed, slowed down or suppressed depending on the viewing direction of a front passenger.

In an exemplary situation, it is assumed below that the vehicle is driving on a freeway and is operated at a higher automation level in the process. The guidance of the vehicle is thus removed from the driver, i.e. the vehicle drives independently without the driver having to intervene in the driving mode. In this situation, the driver can concentrate on a task outside the driving mode, for example by looking at a laptop which he has placed on his thighs.

If, in the automated mode, the vehicle now approaches a vehicle driving in front which is driving significantly more slowly, the automated driving function considers a lane change in order to overtake the slower vehicle. For this purpose, a check is carried out within the scope of the automated driving function in order to determine whether predetermined triggering conditions for the lane change are met. These triggering conditions can be related to a multiplicity of environment-specific and vehicle-specific parameters which are captured and evaluated for the lane change. These include, for example, information about the position, the speed and the distance of adjacent vehicles and the detection and evaluation of lane markings and the availability of an adjacent lane. Furthermore, road-related data such as road geometry, lane width and relevant traffic signs can be taken into account. In addition, vehicle-specific parameters such as the current vehicle speed, the lateral and longitudinal acceleration, the vehicle position, the steering angle, and the turn signal can be included in the check of the triggering conditions for the lane change. If the triggering conditions are met, a lane change is considered.

In this exemplary situation, it is assumed that the driver is looking down at his laptop at the time at which all triggering conditions for the lane change in question are met. His current viewing direction thus deviates from the predefined target viewing direction in which he would look, for example in order to observe the traffic in front of him in the manual driving mode. The method according to the invention now provides for such a deviation of the current viewing direction of the driver from the traffic-facing target viewing direction to be detected and then for the otherwise provided triggering of the lane change to be performed more slowly or suppressed. A lane change is thus at least slowed down when the driver is not looking in the target viewing direction.

The method thus ensures that a lane change takes place in an unchanged manner only when the driver is looking into the traffic area in front of him. A discrepancy between vestibular and visual perception, which could cause kinetosis in the driver, is thus avoided.

In one preferred embodiment, the automated driving function is configured to enable independent driving of the vehicle without intervention by the user. This embodiment is designed to enable a driving mode at higher automation levels, for example at SAE levels L3 to L5. Thus, the lane change controlled according to the invention can take place within the scope of conditional automation, in which the automobile drives independently, but the driver is allowed to intervene in the driving mode if necessary. At a higher automation level, the automobile drives autonomously in certain scenarios without any user intervention, for example on freeways. Finally, the lane change dependent on the viewing direction can be used in particular in a completely autonomous driving mode in which no human driver is required any longer.

Preferably, the slowed-down performance or suppression of the triggering of the lane change is canceled as soon as the comparison reveals a correspondence of the detected viewing direction of the user to the traffic-facing target viewing direction. In this embodiment, the lane change thus takes place in a manner which does not take into account the risk of kinetosis only when the user directs his gaze again to the traffic in front of him.

In this case, the control according to the invention can be designed to wait, without further action as it were, until the comparison of the current viewing direction of the user with the predefined target viewing direction reveals a correspondence, in order only then to trigger the upcoming lane change or to perform the lane change in a manner unaffected with regard to possible kinetosis.

Alternatively, an advisory signal can be output to the vehicle user if the lane change is prevented or slowed down despite the presence of the predetermined triggering conditions. In this embodiment, the user is therefore advised that the triggering conditions for a lane change are met in the current traffic situation and a lane change is thus indicated. The advisory signal causes the user to direct his gaze at the traffic in front of him, which then makes it possible to perform the lane change without regard to possible kinetosis with the aid of the viewing direction detection. The advisory signal can be generated optically, for example by way of subtle light staging which is generated by corresponding lighting means in the interior of the vehicle. For example, however, it is also possible to output an acoustic advisory signal.

In a special embodiment, the speed of the vehicle is detected and the triggering of the lane change is prevented only if the detected speed of the vehicle is additionally greater than a predetermined minimum speed. In this embodiment, in addition to the deviation of the viewing direction of the vehicle user from the traffic-facing target viewing direction, the speed of the vehicle is taken into account, as it were, as a secondary condition for preventing or slowing down the lane change according to the invention. Accordingly, a lane change is suppressed or slowed down only above a certain minimum speed. This takes account of the fact that, during a lane change, experience has shown that kinetosis of the vehicle user can only be expected when the speed is sufficiently high.

However, the control of the lane change according to the invention can also be used even at lower speeds. Thus, even during a lane change which is performed at a lower speed, the lateral acceleration can be relatively high. In this case, it is favorable to control the lane change in a manner that avoids kinetosis, taking into account the combination of longitudinal and lateral accelerations, in particular for users who tend to feel even lower accelerations as unpleasant.

In one preferred embodiment, the viewing direction of the user is detected by means of at least one sensor arranged in the interior of the vehicle. By way of example, it is possible to provide one or more interior cameras which are directed at the user or users whose viewing direction is to be monitored in each case.

The automated driving function can be configured such that the lane change is performed according to predefined lane change dynamics if the triggering conditions are met. If the detected viewing direction deviates from the traffic-facing target viewing direction, the lane change dynamics are changed in such a way that the lane change is performed more slowly than defined by the predefined lane change dynamics or suppressed. In this case, the lane change dynamics can preferably be adjusted individually for the respective user. This makes it possible to determine in which situation the user accepts which lane change dynamics.

According to a further aspect of the invention, an apparatus for controlling an automated driving function of a vehicle is provided. The apparatus comprises at least one sensor which is designed to detect the viewing direction of a user of the vehicle. The apparatus furthermore comprises a control unit which is designed to control the automated driving function. The automated driving function is configured to perform a lane change of the vehicle when predetermined triggering conditions are present. The control unit is designed to compare the detected viewing direction of the user with a traffic-facing target viewing direction. The control unit is furthermore designed to perform the lane change in a slowed-down manner or suppress it despite the presence of the predetermined triggering conditions if the comparison reveals a deviation of the detected viewing direction from the traffic-facing target viewing direction.

The sensor comprises, for example, an interior camera which is integrated in a rearview mirror of the vehicle. Such an interior camera integrated into the rearview mirror can be used to detect the viewing angle of the driver in a particularly reliable manner.

The apparatus having the features of the coordinate claim has the same advantages as the claimed method. In particular, the apparatus can be developed with the features of the dependent claims directed to the method.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective schematic illustration of a vehicle interior; and

FIG. 2 is an image of a driver recorded by an interior camera.

### DETAILED DESCRIPTION OF THE DRAWINGS

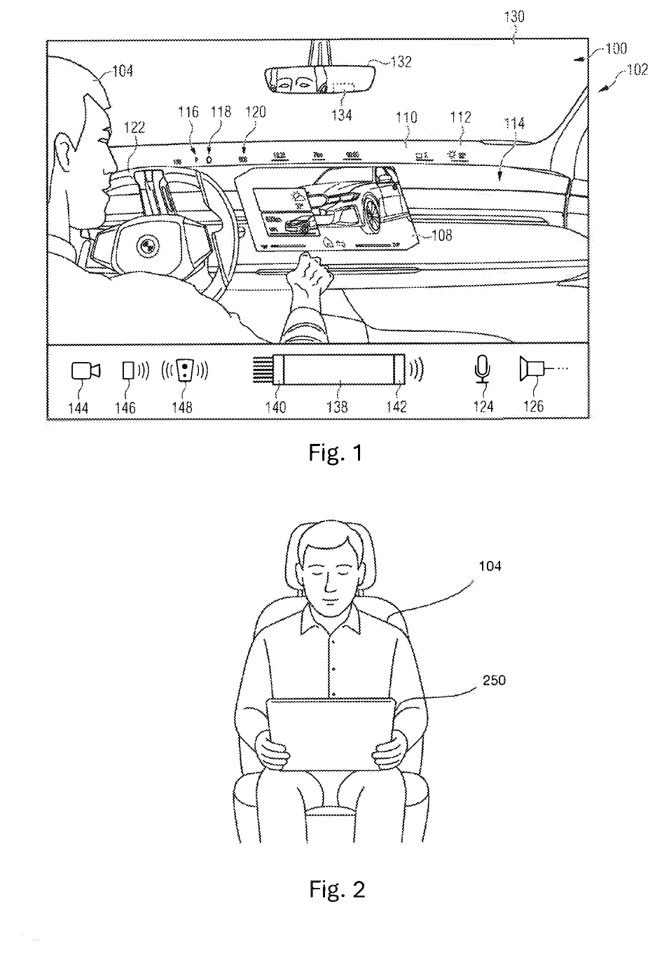

FIG. 1 shows a perspective schematic illustration of a cockpit area 100 of a vehicle 102. The components explained below on the basis of FIG. 1 should be understood to be part of an apparatus which makes it possible to control an automated driving function of the vehicle 102.

A driver 104 sits behind a steering wheel 122 on a driver’s seat of the vehicle 102 that is hidden for simplified illustration. A central information display apparatus 108 embodied as a touch-sensitive screen and a display field 110, which has a plurality of display areas 112, 116, 118, 120 in the example shown, are provided in the cockpit area 100.

The display field 110 is arranged above a dashboard 114 and projects information over the entire width of a windshield 130 of the vehicle 102. In the display field 110, driving data are displayed to the driver 104 in his field of view, e.g. the current gear stage in the display area 116, the current speed of the vehicle 102 in the display area 118, and the remaining range in the display area 120. Other information, such as the outside temperature and the weather, is displayed in the display area 112 further away from the driver 104. Further information may also be displayed in the central information display apparatus 108. The driver 104 can also enter inputs, such as destination inputs for a navigation system, and make and change vehicle settings via the central information display apparatus 108.

An interior rearview mirror 132 and an interior camera 134 integrated in this interior rearview mirror 132 are arranged in the upper region of the windshield 130. In the present exemplary embodiment, the interior camera 134 serves to capture the interior of the vehicle 102 at least in an area in which the upper body of the driver 104 is located.

As illustrated in the lower part of FIG. 1, the vehicle 102 also has a control unit 138 which is connected to the above-mentioned components such as the central information display apparatus 108, the display field 110, the steering wheel 122, and the interior camera 134 via data inputs and data outputs 140. Furthermore, the control unit 138 may be coupled to further input and output units such as a microphone 124 or a loudspeaker 126. In addition, the control unit 138 communicates, for example, with a functional unit which serves to capture the environment of the vehicle 102. Such a functional unit comprises, for example, a front camera 144, a radar sensor 146 and/or a lidar sensor 148 and further sensors such as a rain sensor and a temperature sensor. The coupling to the control unit 138 can be carried out by wire or wirelessly or else with the aid of a bus system and/or network.

The control unit 138 further comprises a communication module 142 which is designed to establish a connection to a telecommunications network, in particular a mobile radio network. Data can be transmitted from and to the vehicle 102, in particular from and/or to a central database and/or processing unit of the vehicle manufacturer and/or a service provider, via the communication module 142.

The control unit 138 is designed to control the vehicle 102 in accordance with an automated driving function. In this case, the driving function is in principle configured such that a lane change of the vehicle 102 is to be triggered when predetermined triggering conditions are present. To determine whether the triggering conditions are met, the control unit 138 uses, among other things, the data provided to it by the front camera 144, the radar sensor 146, and/or the lidar sensor 148. These data represent parameters such as the position, the speed and the distance to adjacent vehicles, the present road geometry, the lane width, traffic signs, etc.

The control unit 138 is furthermore designed such that, in the context of controlling a lane change, it takes into account the viewing direction of the driver 104 in addition to the aforementioned triggering conditions. To this end, the control unit 138 evaluates image data representing an image that the interior camera 134 records of the driver 104. An example of such an image of the driver 104 is shown in FIG. 2.

The interior camera 134 directed at the driver 104 has a field of view that is sufficiently large to capture the eyes of the driver 104. The control unit 138 processes the image data provided by the interior camera 134 in order to determine the viewing direction of the driver 104 therefrom. In the example shown in FIG. 2, the driver 104 is not looking through the windshield 130 at the traffic in front of him, but downward in the direction of a laptop 250 which has been placed on his thighs.

The control unit 138 then compares the detected viewing direction with a traffic-facing target viewing direction. This target viewing direction is predefined as a direction in which the driver 104 looks when observing the traffic in front of him through the windshield 130. If this comparison reveals that the current viewing direction of the driver 104 deviates from the traffic-facing target viewing direction, the lane change is performed in a slowed-down manner under the control of the control unit 138 or else completely suppressed. As a result, the lane change under consideration is thus slowed down or not carried out at all at the given time, even though the triggering conditions provided for the lane change are met.

By slowing down or suppressing the lane change if the currently detected viewing direction of the driver 104 does not correspond to the predefined target viewing direction, it is possible to reliably avoid kinetosis that the driver 104 could suffer due to an otherwise occurring discrepancy between his vestibular perception and his visual perception.

This applies in particular when the lane change is intended to be performed at a high speed. Accordingly, the control unit 138 can also be designed such that, in addition to the predetermined triggering conditions and the viewing direction of the driver 104, it additionally also takes into account the speed of the vehicle 102 for controlling the lane change. In such an embodiment, the control unit 138 detects the speed of the vehicle 102 and compares it with a predefined minimum speed. If the control unit 138 establishes that the speed of the vehicle 102 is less than the minimum speed, the lane change taken into account is not slowed down or suppressed even in the event of a deviation of the current viewing direction of the driver 104 from the predefined target viewing direction. In other words, in this case, the slowing-down or prevention of the lane change according to the invention is used only at a vehicle speed which is so high that there is the risk of kinetosis in the event of a lane change which is unexpected to the driver.

The control of the lane change according to the invention shall be explained below with reference to an example. The assumption is a traffic situation in which the driver 104 drives onto a freeway with his vehicle 102 in a manual driving mode in accordance with the lowest automation level SAE L0. There, the driver 104 activates a higher automation level, such as SAE L3 or L4, which temporarily removes the guidance of the vehicle 102 from him. This automation level allows the driver 104 to open and operate his laptop 250 while the vehicle 102 automatically drives on the freeway. In this case, the control unit 138 continuously monitors the autonomous driving mode, inter alia on the basis of the data provided by the front camera 144, the radar sensor 146 and/or the lidar sensor 148. In particular, the control unit 138 continuously checks whether the triggering conditions for a lane change are present. If the vehicle 102 then approaches, for example, a truck driving ahead, which is driving significantly more slowly, the control unit 138 determines that, from a certain point in time, the aforementioned triggering conditions are met and therefore a lane change is displayed per se. According to the invention, however, the control unit 138 in this case also checks, on the basis of the image data supplied by the interior camera 134, whether the current viewing direction of the user 104 corresponds to the predefined target viewing direction. If the control unit 138 determines such a correspondence, it initiates the triggering of the lane change, whereupon the vehicle 102 overtakes the truck driving more slowly in front of it. If, on the other hand, the control unit 138 establishes that the current viewing direction of the driver 104 deviates from the traffic-facing viewing direction, it prevents the triggering of the lane change or at least ensures that the lane change is performed more slowly than is the case without regard to possible kinetosis. Only when the continuous monitoring of the viewing direction of the driver 104 reveals a correspondence with the target viewing direction does the control unit 138 enable a lane change, as can be carried out without taking into account possible kinetosis. The enabling of course only takes place if the predetermined triggering conditions for the lane changes are still or already met again at this time.

It should be pointed out that the embodiments described above should be understood as being merely exemplary. Thus, in these embodiments, the viewing direction of the driver 104 is determined on the basis of image data provided by the single interior camera 134 integrated into the rearview mirror 132. For the purpose of viewing direction detection, a plurality of interior cameras can also be provided and arranged at other locations in the vehicle interior. Moreover, the determination of the viewing direction is not restricted to the use of a camera. Other types of sensors can also be used, provided that these sensors supply data which make it possible to detect the viewing direction of the driver.

The control of the lane change according to the invention is also not restricted to detecting the viewing direction of a vehicle user located on the driver's seat. In particular, when using the highest automation level, at which the vehicle drives fully autonomously without a driver, the lane change can also be controlled depending on the viewing direction of a vehicle user located on the front passenger seat or in the rear area of the vehicle interior. In the latter case, the viewing directions of a plurality of vehicle occupants can also be taken into account when controlling the lane change. In these embodiments, a suitable number of viewing direction sensors with a corresponding orientation should be provided in order to ensure reliable detection of the viewing direction of the respective vehicle user.

Of course, the situation described above, in which the user 104 works on his laptop 250, should also be regarded only as an example. Further situations in which the user's viewing focus does not face the traffic and therefore kinetosis can be expected in the event of a lane change include, for example, situations in which the user reads, dozes or plays, talks in visual contact with another vehicle occupant, conducts a video conference, watches a film, etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 Cockpit area

102 Vehicle

104 Driver

108 Central information display apparatus

110 Display field

112 Display area

114 Dashboard

116 Display area

118 Display area

120 Display area

122 Steering wheel

124 Microphone

126 Loudspeaker

130 Windshield

132 Interior rearview mirror

134 Interior camera

138 Control unit

140 Data inputs, data outputs

142 Communication module

200 Image

250 Laptop

What is claimed is:

1. A method for controlling an automated driving function of a vehicle, wherein the automated driving function is configured to carry out a lane change of the vehicle when predetermined triggering conditions are present, the method comprising:
detecting a viewing direction of a user of the vehicle;
comparing the detected viewing direction of the user with a traffic-facing target viewing direction;
determining that the detected viewing direction deviates from the traffic-facing target viewing direction; and
performing the lane change in a slowed-down manner or suppressing the lane change notwithstanding the presence of the predetermined triggering conditions.

2. The method according to claim 1, wherein
the automated driving function is configured to enable independent driving of the vehicle without intervention by the user.

3. The method according to claim 1, wherein
the slowed-down performance or the suppression of the lane change is canceled as soon as the comparison reveals a correspondence between the detected viewing direction of the user and the traffic-facing target viewing direction.

4. The method according to claim 1, further comprising:
outputting an advisory signal to the user when the lane change is performed in the slowed-down manner or suppressed despite the presence of the predetermined triggering conditions.

5. The method according to claim 1, further comprising:
detecting a speed of the vehicle; and
performing the lane change in the slowed-down manner or suppressing the lane change only when the detected speed of the vehicle is, additionally, greater than a predetermined minimum speed.

6. The method according to claim 1, wherein
the automated driving function is configured to perform the lane change in accordance with predefined lane change dynamics when the triggering conditions are met; and
the method further comprises changing the lane change dynamics, such that the lane change is performed more slowly than defined by the predefined lane change dynamics or suppressed when the detected viewing direction deviates from the traffic-facing target viewing direction.

7. The method according to claim 1, wherein
the viewing direction of the user is detected by at least one sensor arranged in an interior of the vehicle.

8. An apparatus for controlling an automated driving function of a vehicle, comprising:
at least one sensor which is designed to detect a viewing direction of a user of the vehicle; and
a control unit which is configured to control the automated driving function, wherein the automated driving function is configured to perform a lane change of the vehicle when predetermined triggering conditions are present;
wherein the control unit is further configured to compare the detected viewing direction of the user with a traffic-facing target viewing direction, and
wherein the control unit is configured to perform the lane change in a slowed-down manner or suppress the lane change notwithstanding the presence of the predetermined triggering conditions when the comparison identifies a deviation of the detected viewing direction from the traffic-facing target viewing direction.

9. The apparatus according to claim 8, wherein the sensor comprises an interior camera which is integrated into a rearview mirror of the vehicle.
